(19) United States
(12) Patent Application Publication
(10) Pub. No.: US 2020/0272292 A1
(43) Pub. Date: Aug. 27, 2020

(54) WORKFLOW DRIVEN WORKSPACE USING EXPLORATION AND/OR PRODUCTION DATA IN THE CLOUD

(71) Applicant: SCHLUMBERGER TECHNOLOGY CORPORATION, Sugar Land, TX (US)

(72) Inventors: Brian SPOLNICKI, Katy, TX (US); Vincent BERGBAUER, Katy, TX (US)

(21) Appl. No.: 16/646,310

(22) PCT Filed: Sep. 13, 2018
(86) PCT No.: PCT/US2018/050880

§ 371 Date: Mar. 11, 2020

Related U.S. Application Data
(60) Provisional application No. 62/557,974, filed on Sep. 13, 2017.

(51) Int. Cl. G06F 3/0484; G06Q 10/06; E21B 41/00

(52) U.S. Cl. CPC G06F 3/0484; E21B 49/00; E21B 41/00; G06Q 10/06313

(57) ABSTRACT

Methods, apparatus, systems, and computer-readable media are set forth for providing an application workspace that allows a user to connect applications associated with exploration and production systems. The application workspace can access multiple different applications, such as web applications, and configure the different applications to share data. The shared data can be processed to provide real-time metrics before, during, and/or after an exploration and production related operation. Applications can be added or removed from a stored workspace environment at the request of a user, in order that further insights can be gleaned from new applications.

### CROSS-REFERENCE TO RELATED APPLICATION(S)

This application claims priority to and the benefit of a US provisional application having Ser. No. 62/557,974, filed 13 Sep. 2017, which is incorporated by reference herein.

### BACKGROUND

In the oil and gas industry, data is often generated from a variety of sources for clients that seek to remain privy to the latest trends in exploration and production technology. When data is not consistent or inaccessible, decisions made by such clients may not be the most well-informed, potentially resulting in production inefficiencies. Furthermore, enterprises of all types and sizes are coping with a wider variety of data at a very large scale, making it more difficult than ever to realize production insights. At the same time with the growth in cloud based commodity computing, it is becoming increasingly difficult to package insights for delivery to customers and clients.

### SUMMARY

Methods, apparatus, systems, and computer-readable media are set forth for processing exploration and production data to make such data more readily available for clients seeking to leverage the data for analytics and other services. In some implementations, a method implemented by one or more processors is set forth as including operations such as causing a user interface to be presented at an application workspace. The application workspace can include one or more selectable elements corresponding to one or more applications associated with an exploration and production system. The operations can also include receiving a selection of a first selectable element and a second selectable element. The first selectable element and the second selectable element can each be associated with separate applications of the one or more applications. The operations can further include causing data to be shared between the separate applications according to a backend process for managing exploration and production related data. Optionally, the method can include, generating, based on the data shared between the separate applications, a stored workspace environment entry that identifies each of the separate applications. In some implementations, the operations can include receiving a separate selection of an analysis application. The analysis application can be configured to provide real-time data based on the data shared between the separate applications. The real-time data can include a production rate, a construction metric, or a quality of service metric. The data shared between the separate applications can includes geographic data corresponding to the exploration and production system. In other implementations, the method can include an operation of receiving a separate selection at the user interface to remove an associated application from the stored workspace environment. Receiving the separate selection can cause a portion of the data shared between the separate applications to be disassociated from the stored workspace environment. The separate applications can include at least a web application that is hosted by a remote device that is separate from a server device that hosts the stored workspace environment.

Some implementations also include a system including one or more processors and memory configured to store instructions that, when executed by one or more processors, cause the one or more processors to perform any of the aforementioned operations, as well as a non-transitory computer readable medium configured to store instructions that, when executed by one or more processors, cause the one or more processors to perform any of the aforementioned operations.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIGS. 1.1-1.4 illustrate simplified, schematic views of an oilfield having subterranean formation containing reservoir therein in accordance with implementations of various technologies and techniques described herein.

FIG. 2 illustrates a schematic view, partially in cross section of an oilfield having a plurality of data acquisition tools positioned at various locations along the oilfield for collecting data from the subterranean formations in accordance with one or more embodiments.

FIG. 3 illustrates a production system for performing one or more oilfield operations in accordance with one or more embodiments.

FIG. 4 illustrates a system in accordance with one or more embodiments.

FIG. 5 illustrates a system for providing a workflow driven exploration and production system in a cloud environment.

FIG. 6 illustrates a method for providing an application workspace for analyzing and/or processing exploration and production related data.

FIG. 7 illustrates a computing system within which the herein described techniques may be implemented in some implementations.

FIG. 8 illustrates a network within which the herein described techniques may be implemented in some implementations.

### DETAILED DESCRIPTION OF THE INVENTION

The described implementations relate to systems, methods, and apparatus for processing exploration and/or production data to make such data more readily available for clients seeking to leverage the data for analytics and other services. In this regard, the term “exploration and production” may refer to exploration-related activities, production-related activities or activities associated with both exploration and production aspects of natural resource recovery. A database that provides exploration and production data can reference numerous data entities that can identify portions of an exploration and production system. For instance, data entities can identify different oil fields and relationships between the different oil fields. Specifically, the implementations relate to a workspace that is configurable and allows multiple exploration and production application components to be built into a user-defined workflow. The workspace can include a component that provides access to multiple different exploration and production applications. The workspace can further include a component that can be integrated into a user-defined workspace to allow for web application access via the workspace. In some implementations, a quality reporting service can operate in the background (e.g., as a background script or application) for analyzing data provided for the workspace and delivering further data via the dynamic workspace component.

The components of a user-defined workspace can be applications that are native web applications and/or launch points or shortcuts to other applications. The components can be delivered from applications in multiple environments (e.g., cloud endpoints, enterprises, data centers, and/or any other environment). Furthermore, the components can incorporate various activities and functions according to their relationship to exploration and production workflows. This can allow for more efficient switching between applications. Moreover, while a user is working with a component application of a workspace, the data being accessed by the component application can be available across multiple applications. The availability of such data can be made possible through a backend infrastructure of the workspace, and any changes to the data can be presented in real-time through other component applications, as desired. Component applications can include, for example, data loaders, real-time or near real-time production dashboards, real-time or near real-time drilling dashboards, application launchers, high performance computing results, drill planning, and/or document delivery systems, among others.

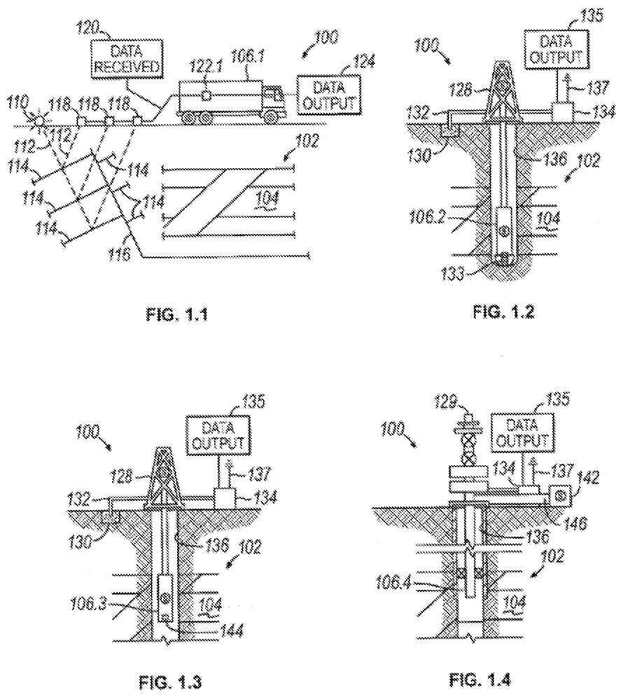

FIGS. 1.1-1.4 illustrate simplified, schematic views of an oilfield 100 having subterranean formation 102 containing reservoir 104 therein in accordance with implementations of various technologies and techniques described herein. FIG. 1.1 illustrates a survey operation being performed by a survey tool, such as seismic truck 106.1, to measure properties of the subterranean formation. The survey operation is a seismic survey operation for producing sound vibrations. In FIG. 1.1, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein. In general, wireline tool 106.3 may thereby collect acoustic data and/or image data for a subsurface volume associated with a wellbore.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

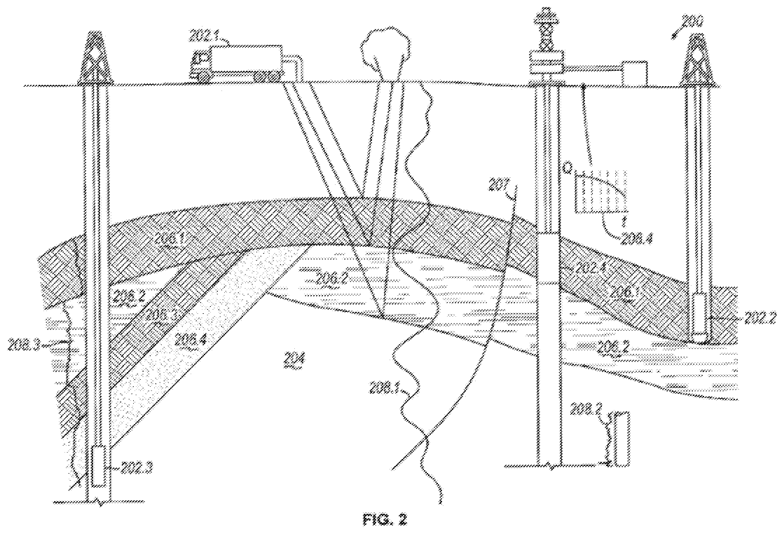

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

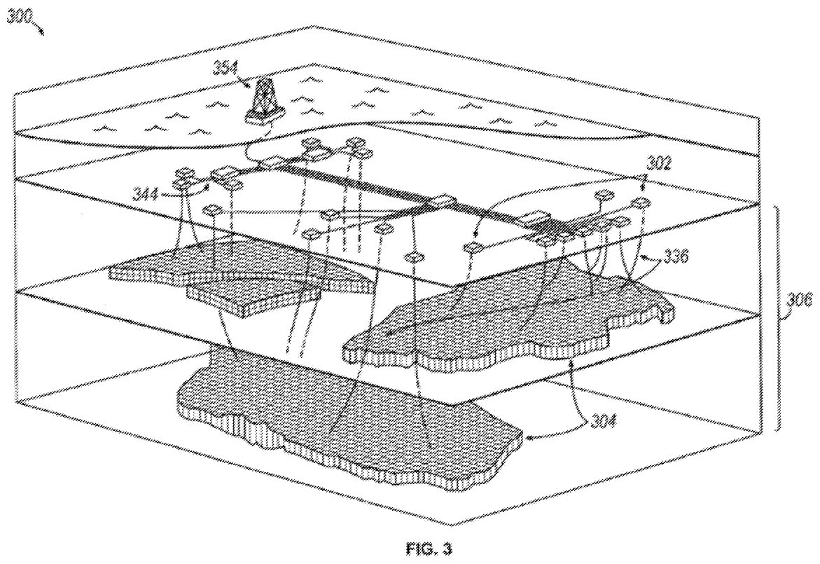

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

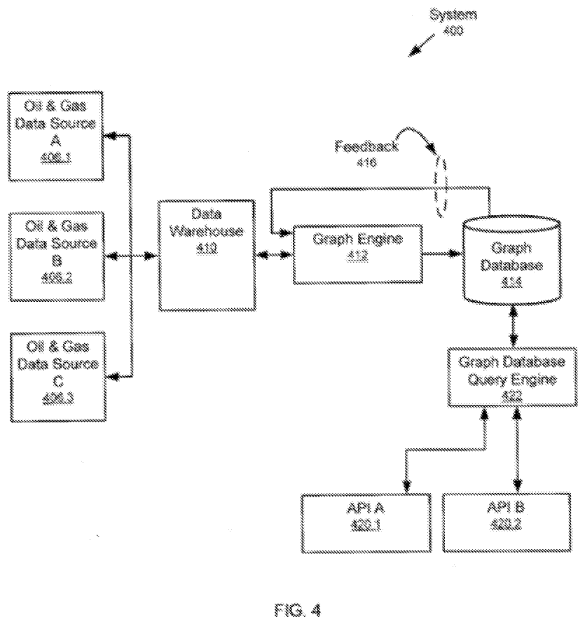

FIG. 4 shows a system 400 in accordance with one or more embodiments. The system 400, or part of the system 400, may be located in a surface unit (e.g., surface unit (134)). As shown in FIG. 4, the system 400 has multiple components including multiple data sources (e.g., OG Data Source A 406.1, OG Data Source B 406.2, OG Data Source C 406.3, a data warehouse 410, a graph engine 412, a graph database 414, a graph database query engine 422, and one or more APIs (e.g., API A 420.1, 420.2). Each of the components (406.1, 406.2, 406.3, 410, 412, 414, 422, 420.1, 420.2) may be located on the same computing device (e.g., server, mainframe, personal computer, laptop, tablet PC, smart phone, kiosk, etc.) or on different computing devices connected by a network of any size or topology with wired and/or wireless segments.

As shown in FIG. 4, the system 400 has multiple OG data sources 406.1, 406.2, 406.3. These OG data sources 406.1, 406.2, 406.) may correspond to sensors or measurement tools on site in an oilfield. These OG data sources 406.1, 406.2, 406.3 may correspond to external databases or websites. The OG data sources 406.1, 406.2, 406.3) output data items. These data items may be of any type or size relevant to an oilfield. For example, these data items may include well fracturing depth-temperature-energy band data (real-time or playback from previously fractured wells), user annotations and comments, any open literature, etc.

In one or more embodiments, the system 400 includes data warehouse 410. The data warehouse 410 may correspond to one or more repositories. The data warehouse (410) ingests (e.g., obtains and stores) the data values from the OG data sources 406.1, 406.2, 406.3. The data warehouse 410 is effectively a consolidated source of data items regarding an oilfield.

In one or more embodiments, the system 400 includes the graph engine 412. The graph engine 412 applies one or more transformations (e.g., pipelines) to the data items to generate one or more transformed data items. Application of one or more transformations may be triggered by various conditions (e.g., changes in temperature, pressure, depth, composition in well, etc.). Application of one or more transformations may occur at set times or milestones. One or more transformations may be custom designs. One or more transformation include machine learning. Example transformations include: data cleansing (bound checks, NaN), conversion to different format, aggregates based on one or more state changes, statistical calculations (variance, mode, standard deviation).

In one or more embodiments, the system 414 includes the graph database 414. The graph database 414 implements a knowledge graph for an oilfield. In other words, the graph database 414 is an OG graph database. The graph database 414 includes one or more nodes connected by one or more edges. Each node may correspond to one or more entities in the oilfield. Each edge is a relationship between two or more nodes. In one or more embodiments, the graph engine 412 modifies (e.g., populates, enriches, shrinks, etc.) the graph database 414 based on the transformed data items. This may include modifying existing nodes and edges, removing existing nodes and edges, and/or inserting new nodes and new edges. The nodes or edges may include the transformed data items. For example, nodes may correspond to wells, client/customer ID, chemicals used in the oilfield. Edges may correspond to any links between these nodes & disconnected data silos.

As shown in FIG. 4, there exists a feedback loop 416 from the graph database 414 to the graph engine 412. One or more node or edges in the graph database 414 may be data values that are transformed by the graph engine 412.

In one or more embodiments, the system 400 includes the graph database query engine 422. The graph database query engine 422 receives user requests regarding an oilfield entity and generates a result to the request. The result may be generated by traversing the graph database 414. The result may be a summary or digest regarding the oilfield entity. For example, the user request may be: “Give me a summary of all wells fractured between December 01 and December 31 in year XXXX for client A.”

In one or more embodiments, the system 400 includes multiple APIs 420.1, 420.2. It is through the APIs 420.1, 420.2 that users may issue request and obtain (e.g., view, print) results in response to the request. APIs provide data to monitoring front-end and may have a rich user interface to view data close to real-time in the form of heat maps, line plots, etc.

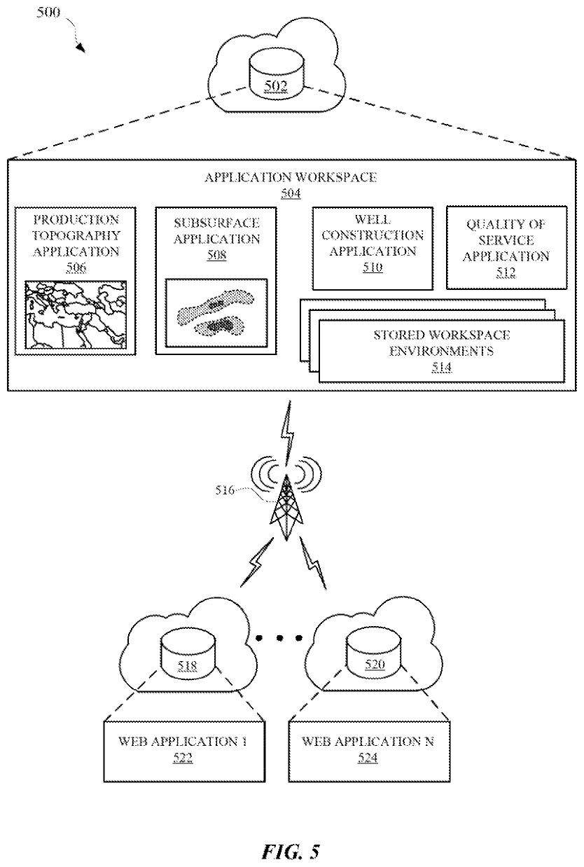

FIG. 5 illustrates a system 500 for providing a workflow driven exploration and production system in a cloud environment, and which, while not required, may access data from a data lake that can be provided by or is otherwise accessible to system 400 of FIG. 4. The system 500 can include one or more remote devices 502 capable of operation an application workspace 504. The application workspace 504 can be configurable by a user and/or customer in order to allow multiple exploration and production related applications to be in communication using a user-defined workflow. Independent software components can be integrated into the user-defined workflow, such as web applications (e.g., one or more of “web application 1” 522 through “web application N” 524). Each of the web applications can be hosted at a remote device (e.g., remote device 518 and/or remote device 520) that is separate from the remote device 502 that hosts the application workspace 504. For instance, a third party application that provide third party data can be hosted as a separate server from the remote device 502, however, a user can access the third party application through the application workspace 504. In this way, a user is able to incorporate the third party application and/or the third party data into the application workflow they are creating. Alternatively, data can be provided by any one of the elements provided in FIG. 4, such as the oil and gas data source A 406.1, B 406.2, and/or C 406.3, the data warehouse 410, and/or any other portion of the system 400.

In some implementations, the remote device 502 can host a quality of service application 512, which can operate as a background service to analyze user data over a network 516, such as the internet and/or one or more public or private networks. The quality of service application 512 can then deliver real-time data, based any analysis, via the dynamic application workspace 504. In some implementations, the application workspace 504 can include or otherwise access a production topography application 506 capable of providing status data related to the production operations occurring at different geographic locations. The production data can identify a geographic location of a production operation, a status of the production operation, a type of production operational (e.g., oil, gas, etc.), a rate of production of the operation, and/or any other metric that can be associated with an oil and/or gas production operation.

In some implementations, the application workspace 504 can include or otherwise access a subsurface application 508 capable of providing data related to subsurface condition at a location of a production operation. For instance, a production operation (e.g., an oil drilling operation) can be identified by the production topography application 506 and also the subsurface application 508. The production topography application 506 can provide status related data regarding production rates for the production operation. Additionally, the subsurface application 508 can provide data related to subsurface conditions at or proximate to the production operation. For instance, the subsurface conditions can be monitored by one or more sensors that can be in direct or indirect communication with the remote device 502, or other device that is accessible to the subsurface application 508. The subsurface application 508 can then share the subsurface condition data with the production topography application 506 and/or any other application of the application workspace 504 in order to provide additional insights and analysis to a user.

In other implementations, the application workspace 504 can include a well construction application 510 capable of product data related to a construction of a well for an exploration and production system. The well construction application 510 can receive data directly or indirectly from a wellsite where the well is being constructed. Data from the wellsite can be shared with other applications of the application workspace 504 in order for users to make decisions about to best proceed with well construction.

In yet other implementations, the application workspace 504 can include stored workspace environments 514. A stored workspace environment 514 can include one or more applications designated by a user for receiving data. For instance, a user can designate multiple applications to be presented at a user interface of the remote device 502 and for sharing data between the applications. The designated applications can be identified in one or more entries stored at the remote device 502 in association with a stored workspace environment 514. In this way, the user can select the stored workspace environment 514 as a shortcut for interacting with multiple connected applications, without having to individually open each application again.

In some implementations, the application workspace 504 can be provided at a user interface of a web browser that is capable of accessing various applications over a network. The user interface can operate as an application canvas for connecting multiple different applications associated with one or more different exploration and production systems. A user interface can represent various graphical elements associated with the different applications. For instance, the graphical elements can represent real-time data as graphs, charts, images, and/or other visualizations that can provide a user with a snapshot of certain aspects of an exploration and production system. In some implementations, information presented at the user interface can be based on data provided from multiple different applications that have been connected or otherwise in communication as a result of selections made by a user of the application workspace 504. Data can be communicated between applications through backend architecture of the application workspace 504. When a user seeks to end a session at the application workspace 504, the user can choose to store the arrangement of applications as a stored workspace environment 514. Thereafter, when a user seeks to initialize the applications again, the user can select the corresponding stored workspace environment 514, thereby causing the backend architecture to reinitialize for sharing data between the applications.

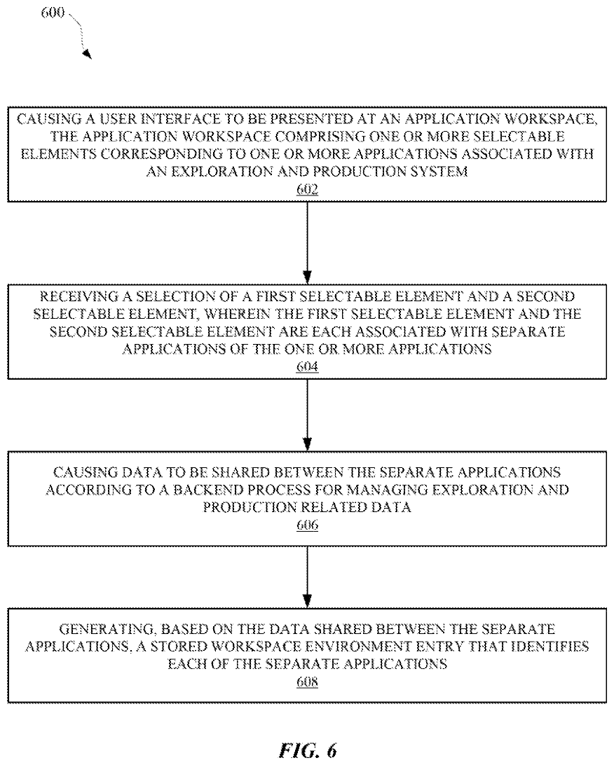

FIG. 6 illustrates a method 600 for providing an application workspace for analyzing and/or processing exploration and production related data. The method 600 can be performed by one or more computing devices and/or any other apparatus capable of receiving exploration and production related data. The method 600 can include an operation 600 of causing a user interface to be presented at an application workspace. The application workspace can include one or more selectable elements corresponding to one or more applications associated with an exploration and production system. For instance, the one or more selectable elements can be links or graphical icons presented at a display of a computing device.

The method 600 can further include an operation 604 of receiving a selection of a first selectable element and a second selectable element. The first selectable element and the second selectable element can each be associated with separate applications of the one or more applications. For instance, the first selectable element can identify a first application and the second selectable element can identify a second application. Each of the first application and the second application can be hosted at separate server devices that are connected over a network that is accessible to the exploration and production system.

The method 600 can also include an operation 606 of causing data to be shared between the separate applications according to a backend process for managing exploration and production related data. The backend process can be employed by architecture of the application workspace. For instance, although frontend architecture can allow a user to make selections about the applications to link for a particular workspace environment, the backend architecture of the application workspace can allow applications to share resources. For instance, the first application can be a planning and/or economics related application and the second application can be a well construction application. By sharing resources, such as collected data and/or schedule data, progress metrics and/or material usage estimates can be generated in real-time for the user to observe at the application workspace.

The method 600 can further include an operation 608 of generating, based on the data shared between the separate applications, a stored workspace environment entry that identifies each of the separate applications. The stored workspace environment entry can be stored at a remote device that hosts the application workspace, and/or a server device that is otherwise available to the application workspace. The stored workspace environment entry can be stored in a table or other database that includes other entries corresponding to other stored workspace environments. The stored workspace environments can be generated at the direction of one or more different users, companies, or other entities. For instance, multiple different users can collaborate on linking multiple different applications for generating a stored workspace environment, which they can access individually or simultaneously from separate devices.

In some implementations, common usages of different components may be tracked, and can result in one component being automatically suggested to a user when another component is executed or started. In addition, in some implementations, connections between components may be used to implicitly establish suggestion relationships between components. Further, in some embodiments, different components may have access to only a portion of a full data model, and as such the composite operation of all of the components may utilize a greater portion of the full data model. In addition, data may automatically flow from component to component, and in some instances, tracked user behavior may be used to suggest placement of different components relative to one another to establish likely producer/consumer relationships between components.

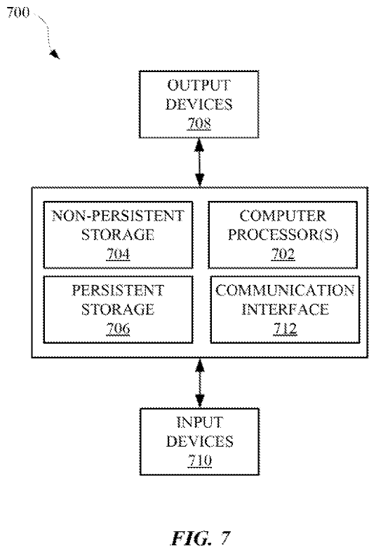

Embodiments may be implemented on a computing system. Any combination of mobile, desktop, server, router, switch, embedded device, or other types of hardware may be used. For example, as shown in FIG. 7, the computing system 700 may include one or more computer processors 702, non-persistent storage 704 (e.g., volatile memory, such as random access memory (RAM), cache memory), persistent storage 706 (e.g., a hard disk, an optical drive such as a compact disk (CD) drive or digital versatile disk (DVD) drive, a flash memory, etc.), a communication interface 712 (e.g., Bluetooth interface, infrared interface, network interface, optical interface, etc.), and numerous other elements and functionalities.

The computer processor(s) 702 may be an integrated circuit for processing instructions. For example, the computer processor(s) may be one or more cores or micro-cores of a processor. The computing system 700 may also include one or more input devices 710, such as a touchscreen, keyboard, mouse, microphone, touchpad, electronic pen, or any other type of input device.

The communication interface 712 may include an integrated circuit for connecting the computing system 700 to a network (not shown) (e.g., a local area network (LAN), a wide area network (WAN) such as the Internet, mobile network, or any other type of network) and/or to another device, such as another computing device.

Further, the computing system 700 may include one or more output devices 708, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 702, non-persistent storage 704, and persistent storage 706. Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments.

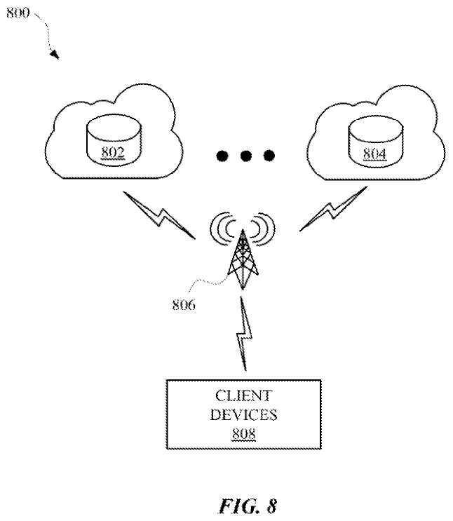

The computing system 700 in FIG. 7 may be connected to or be a part of a network, such as the network 806 described by system 800 of FIG. 8. For example, as shown in FIG. 8, the network 806 may include multiple nodes (e.g., node X 802, node Y 804). Each node may correspond to a computing system, such as the computing system shown in FIG. 7, or a group of nodes combined may correspond to the computing system shown in FIG. 7. By way of an example, embodiments may be implemented on a node of a distributed system that is connected to other nodes. By way of another example, embodiments may be implemented on a distributed computing system having multiple nodes, where each portion of the embodiment may be located on a different node within the distributed computing system. Further, one or more elements of the aforementioned computing system 700 may be located at a remote location and connected to the other elements over a network.

Although not shown in FIG. 8, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X 802, node Y 804) in the network 806 may be configured to provide services for a client device 808. For example, the nodes may be part of a cloud computing system. The nodes may include functionality to receive requests from the client device 708 and transmit responses to the client device 808. The client device 808 may be a computing system, such as the computing system shown in FIG. 7. Further, the client device 1008 may include and/or perform all or a portion of one or more embodiments.

The computing system or group of computing systems described in FIGS. 9 and 10 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

The above description of functions present only a few examples of functions performed by the computing system of FIG. 7 and the nodes and/or client device in FIG. 8. Other functions may be performed using one or more embodiments.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A method for one or more processors, the method comprising:
causing a user interface to be presented at an application workspace, the application workspace comprising one or more selectable elements corresponding to one or more applications associated with an exploration and production system;
receiving a selection of a first selectable element and a second selectable element, wherein the first selectable element and the second selectable element are each associated with separate applications of the one or more applications; and
causing data to be shared between the separate applications according to a backend process for managing exploration and production related data.

2. The method of claim 1, further comprising:
receiving a separate selection of an analysis application, the analysis application configured to provide real-time data based on the data shared between the separate applications.

3. The method of claim 2, wherein the real-time data includes a production rate, a construction metric, or a quality of service metric.

4. The method of claim 1, wherein the data shared between the separate applications includes geographic data corresponding to the exploration and production system.

5. The method of claim 1, further comprising:
receiving a separate selection at the user interface to remove an associated application from the stored workspace environment.

6. The method of claim 5, wherein receiving the separate selection causes a portion of the data shared between the separate applications to be disassociated from the stored workspace environment.

7. The method of claim 1, wherein the separate applications include at least a web application that is hosted by a remote device that is separate from a server device that hosts the stored workspace environment.

8. The method of claim 1, further comprising:
generating, based on the data shared between the separate applications, a stored workspace environment entry that identifies each of the separate applications.

9. A system, comprising:
one or more processors; and
memory configured to store instructions that, when executed by one or more processors, cause the one or more processors to perform operations that include:
causing a user interface to be presented at an application workspace, the application workspace comprising one or more selectable elements corresponding to one or more applications associated with an exploration and production system;
receiving a selection of a first selectable element and a second selectable element, wherein the first selectable element and the second selectable element are each associated with separate applications of the one or more applications; and
causing data to be shared between the separate applications according to a backend process for managing exploration and production related data.

10. The system of claim 9, further comprising:
receiving a separate selection of an analysis application, the analysis application configured to provide real-time data based on the data shared between the separate applications.

11. The system of claim 10, wherein the real-time data includes a production rate, a construction metric, or a quality of service metric.

12. The system of claim 9, wherein the data shared between the separate applications includes geographic data corresponding to the exploration and production system.

13. The system of claim 9, wherein the operations further include:
receiving a separate selection at the user interface to remove an associated application from the stored workspace environment.

14. The system of claim 12, wherein receiving the separate selection causes a portion of the data shared between the separate applications to be disassociated from the stored workspace environment.

15. The system of claim 14, wherein the separate applications include at least a web application that is hosted by a remote device that is separate from a server device that hosts the stored workspace environment.

16. The system of claim 9, wherein the operations further include:
generating, based on the data shared between the separate applications, a stored workspace environment entry that identifies each of the separate applications.

17. A non-transitory computer readable medium configured to store instructions that, when executed by one or more processors, cause the one or more processors to perform operations that include:
causing a user interface to be presented at an application workspace, the application workspace comprising one or more selectable elements corresponding to one or more applications associated with an exploration and production system;
receiving a selection of a first selectable element and a second selectable element, wherein the first selectable element and the second selectable element are each associated with separate applications of the one or more applications; and
causing data to be shared between the separate applications according to a backend process for managing exploration and production related data.

18. The non-transitory computer readable medium of claim 17, further comprising:
receiving a separate selection of an analysis application, the analysis application configured to provide real-time data based on the data shared between the separate applications.

19. The non-transitory computer readable medium of claim 18, wherein the real-time data includes a production rate, a construction metric, or a quality of service metric.

20. The non-transitory computer readable medium of claim 17, wherein the data shared between the separate applications includes geographic data corresponding to the exploration and production system.

21. The non-transitory computer readable medium of claim 17, further comprising:
receiving a separate selection at the user interface to remove an associated application from the stored workspace environment.

22. The non-transitory computer readable medium of claim 21, wherein receiving the separate selection causes a portion of the data shared between the separate applications to be disassociated from the stored workspace environment.

23. The non-transitory computer readable medium of claim 17, wherein the separate applications include at least a web application that is hosted by a remote device that is separate from a server device that hosts the stored workspace environment.

24. The non-transitory computer-readable medium of claim 17, wherein the operations further include:
generating, based on the data shared between the separate applications, a stored workspace environment entry that identifies each of the separate applications.
